(19) United States
(12) Patent Application Publication
(10) Pub. No.: US 2022/0052572 A1
(43) Pub. Date: Feb. 17, 2022

(54) ELECTRIC MACHINE AND HYBRID ELECTRIC VEHICLE

(71) Applicant: Rolls-Royce Deutschland Ltd & Co KG, Blankenfelde-Mahlow (DE)

(72) Inventor: Mykhaylo Filipenko, Erlangen (DE)

(21) Appl. No.: 17/280,236

(22) PCT Filed: Sep. 26, 2019
(86) PCT No.: PCT/EP2019/076090

§ 371 Date: Mar. 26, 2021

(30) Foreign Application Priority Data
Sep. 28, 2018 (DE) 10 2018 216 735.4
Mar. 6, 2019 (DE) 10 2019 203 063.7

(51) Int. Cl. H02K 3/02; B64D 27/24; H02K 1/16; H02K 55/00

(52) U.S. Cl. CPC H02K 3/02; B64D 27/24; B64D 2027/026; H02K 55/00; H02K 1/16

(57) ABSTRACT

The disclosure relates to an electric machine and a hybrid electric vehicle. The electric machine includes at least one first group of superconducting coils arranged to guide a magnetic flow at least along a U-shaped course. The hybrid electric aircraft is, in particular, an aeroplane and has an electric machine of this type.

The present patent document is a § 371 nationalization of PCT Application Serial No. PCT/EP2019/076090, filed Sep. 26, 2019, designating the United States, which is hereby incorporated by reference, and this patent document also claims the benefit of German Patent Application No. 10 2018 216 735.4, filed Sep. 28, 2018, and German Patent Application No. 10 2019 203 063.7, filed Mar. 6, 2019, which are also hereby incorporated by reference.

### TECHNICAL FIELD

The disclosure relates to an electric machine and a hybrid electric vehicle.

### BACKGROUND

Numerous technical applications require electric machines with the highest possible mass-related power, e.g., with the highest possible power per kilogram of mass. Generators and motors with a power density of at least 20 kW/kg are required for the electrification of aviation in particular.

The electrical power density of a machine is essentially proportional to the electrical current of the stator and the magnetic field of the rotor. Because superconducting spools may provide significantly higher magnetic flux densities of around three to four Tesla compared to those of the strongest permanent magnets at room temperature, specifically only around 1.2 Tesla, the power density may be significantly increased when using superconducting spools.

Despite such high field strengths, magnetic flux-conducting material are used on the stator in order to shield the magnetic field. The shielding requires yokes, the mass of which cannot be further reduced, because ferromagnetic materials have a saturation magnetization, in the case of iron of about 2.2 Tesla. If this saturation magnetization is exceeded, the yoke may no longer fulfill its flux-conducting and shielding function and the magnetic field may spread outside the machine. This may disadvantageously lead to electromagnetic interference (EMI) and also reduce the efficiency of the machine. The yoke is therefore the limiting factor even in superconducting machines.

In the case of conventional machines, Halbach arrays of magnets may be used to carry flux within the magnets themselves rather than within a yoke. In a Halbach configuration, the flux is as it were conducted within the magnets. This means that there is no longer a need for a yoke on the “back” of the magnets to guide the flux. Halbach configurations may be produced by magnetizing individual, small magnets in a normal north-south configuration and then mechanically bringing them together and adhesively bonding them in the corresponding configuration.

With such a Halbach array, a so-called “external rotor configuration”, in which the rotor is arranged outside the stator, may be implemented. The magnetic flux is conducted on the outside in the magnets, so that it cannot escape to the outside.

Also known are superconducting machines in which superconducting excitation spools are arranged in the stator and the winding in which voltage is induced is arranged in the rotor. In the case of such electric machines, the yoke may be omitted. Because the winding is arranged on the rotor, such electric machines require slip rings in order to conduct the current from rotating parts to stationary parts of the electric machine. However, on high-speed machines, slip rings are heavy and wear out quickly.

### SUMMARY AND DESCRIPTION

Against this background of the prior art, the object of the disclosure is to create an electric machine which may provide a high-power density. A further object is to create a hybrid electric vehicle, in particular an aerial vehicle, which has a high mass-related power. This object of the disclosure is achieved by an electric machine as disclosed herein. The scope of the present disclosure is defined solely by the appended claims and is not affected to any degree by the statements within this summary. The present embodiments may obviate one or more of the drawbacks or limitations in the related art.

The electric machine has at least one first group of superconducting spools, which are arranged to guide a magnetic flux at least along a u-shaped profile.

According to the disclosure, a Halbach array is therefore made possible by superconducting spools. The group of superconducting spools may intrinsically conduct magnetic flux without requiring an additional yoke. Due to the fact that it is possible to dispense with a yoke, the mass-related power may therefore be increased significantly.

In addition, all mechanical components that are necessary to support the centrifugal force may be moved outward so that these components do not have to be provided in the air gap. The air gap may consequently be designed to be smaller and the torque may therefore be increased further.

In certain examples, the superconducting spools of the first group of the electric machine may surround the u-shaped profile and/or a longitudinal center line of the u-shaped profile, in particular circumferentially. In such a geometry, the magnetic flux may be guided analogously to classic spools, e.g., analogously to non-superconducting spools.

In certain examples, the superconducting spools of the electric machine extend with their winding planes along curve radii of a curve section of the profile.

In certain examples, the u-shaped profile advantageously extends within a profile plane and the spools extend with their winding planes perpendicular to the profile plane.

In certain examples, at least the first group is suitably arranged on a rotor or stator of the electric machine.

In an advantageous development, the electric machine has at least one further group of superconducting spools, with legs of the u-shaped profile respectively extending in the same direction from the apex. In this development, a large number of adjacent magnetic poles may be implemented without a heavy yoke or other yoke being required.

In a development, the electric machine has at least one further group of superconducting spools, with legs of the u-shaped profile of at least two groups being directed toward one another. In this development, for instance spools of a stator may be introduced between the legs directed toward one another so that the u-shaped profiles may be closed to form a magnetic flux circuit by the spools of the stator.

In certain examples, the electric machine is advantageously an electric motor and/or a generator.

In certain examples, the superconducting spools of the electric machine may be formed by yttrium-barium-copper oxide. Yttrium-barium-copper oxide is an established high-temperature superconductor and allows the production or use of superconducting spools according to known and established processes.

The hybrid electric vehicle is in particular an aerial vehicle, (e.g., an aircraft), and has an electric machine as described above.

Electric machines with a power density of 30-40 kW/kg may be implemented. With aerial vehicles with electric machines, the electrification of aviation may take a clear step toward practical solutions.

The wind power plant has an electric machine as described above. The increased efficiency of electric machines, such as in particular generators, that is possible allows the production of significantly more efficient wind power plants.

### BRIEF DESCRIPTION OF THE DRAWINGS

The disclosure is explained in more detail below with reference to the exemplary embodiments shown in the drawing, in which:

FIG. 1 depicts an example of a sector of an electric machine with a group of superconducting rotor spools schematically in a view in the direction of an axis of rotation of a rotor of the machine.

FIG. 2 depicts a further exemplary embodiment of a group of superconducting rotor spools schematically in a view in the direction of the axis of rotation.

FIG. 3 depicts a further example of an electric machine with a double rotor with a further exemplary embodiment of a group of superconducting rotor spools schematically in a side view in the direction perpendicular to the axis of rotation of the double rotor.

FIG. 4 depicts a further example of an electric machine schematically in a side view in the direction perpendicular to the axis of rotation of the rotor.

### DETAILED DESCRIPTION

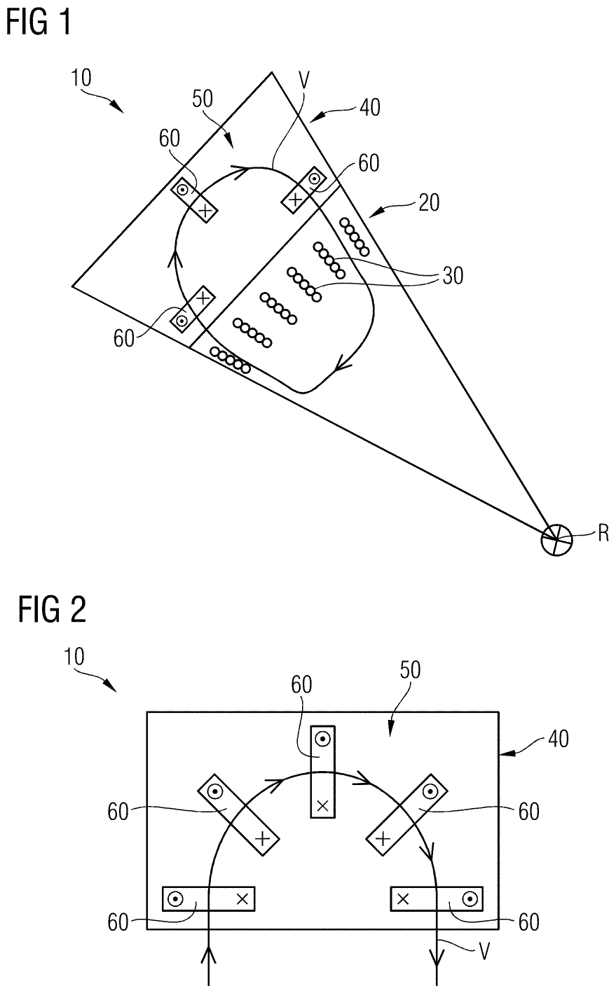

The sector of an electric machine 10 shown in FIG. 1 shows a stator 20 with conventional stator spools 30 and a rotor 40 rotatable about an axis of rotation R with a first group 50 of superconducting rotor spools 60.

In the exemplary embodiment shown in FIG. 1, the group 50 of superconducting rotor spools 60 are arranged with their winding planes perpendicular to the plane of the drawing. Those directions of extent of the winding planes which run parallel to the plane of the drawing extend along the three ends of the bars of an imaginary T shape. Thus, beginning from a first end of a transverse bar of the T shape, via the end of a central bar of the T shape to the second end of the transverse bar of the T shape, the superconducting rotor spools 60 are progressively rotated respectively and mutually by 90 degrees. The superconducting rotor spools 60 are wound and energized in such a way that, with this imaginary rotation of the superconducting rotor spools 60 relative to one another by 90 degrees, the energization of the superconducting rotor spools 60 does not otherwise change apart from this rotation. Consequently, the magnetic flux is guided in the superconducting rotor spools 60 in such a way that, starting from the first end of the transverse bar of the T shape, the magnetic flux runs perpendicular to the longitudinal extent of the transverse bar, then at the end of the central bar of the T shape runs perpendicular to the longitudinal extent of this central bar and then at the second end of the transverse bar of the T shape runs perpendicular to the longitudinal extent of the transverse bar. In the imaginary T shape, the transverse bar is arranged near that end of the rotor 40 facing the stator, and the central bar extends away from the transverse bar in the direction away from the stator.

Consequently, the magnetic flux of the superconducting rotor spools 60 describes a profile V in the form of a U shape around the imaginary connection point of the transverse bar and the central bar of the imaginary T shape, the U shape having legs at the end of the transverse bar and an apex at the end of the central bar.

The legs of the U shape of the profile V of the magnetic flux are oriented parallel to one another and, viewed from the apex of the U shape of the profile, extend in the direction of the stator.

The group 50 of rotor spools 60 continues circumferentially in further sectors of the electric machine 10.

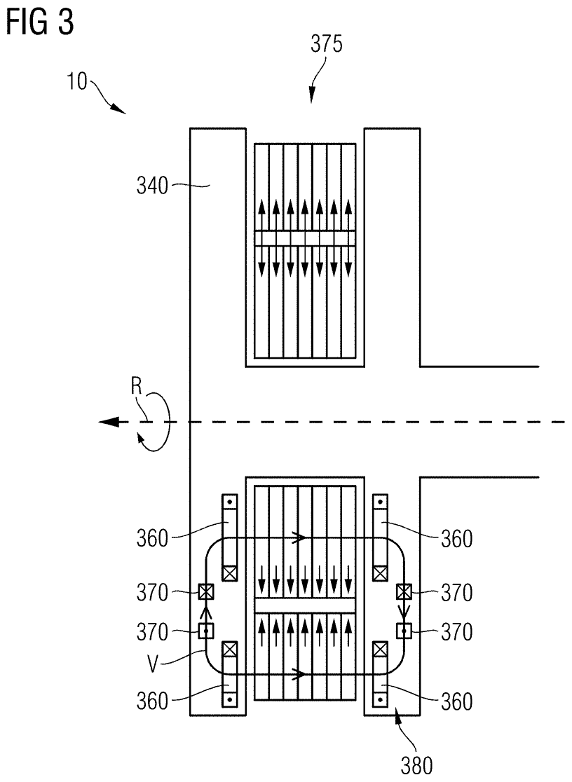

In principle, the group 50 of rotor spools 60 may differ in detail from the previously described group 50 of rotor spools 60. For example, additional rotor spools 60 may be provided, arranged between the already existing rotor spools 60 in such a way that the winding planes of the superconducting rotor spools 60 are not respectively rotated by 90 degrees in relation to one another as described above, but rather as in FIG. 2 extend radially from the imaginary connection point between the transverse bar and the center bar offset by 45 degrees in each case in the manner of spokes.

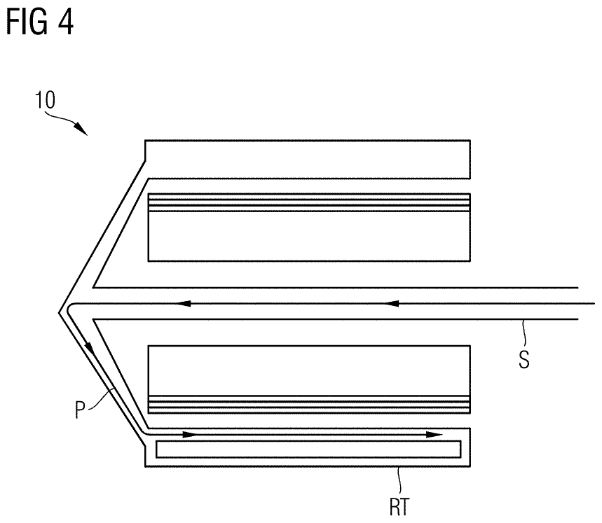

In the case of the double rotor 340 shown in FIG. 3, instead of a single rotor spool 360 with a winding plane extending along the end of the center bar and perpendicular to the plane of the drawing, there are two rotor spools 370 parallel to one another, which are however dimensioned smaller in terms of winding circumference.

In the exemplary embodiment shown in FIG. 3, the rotor spools 360, 370 are arranged with the u-shaped profile in such a way that the legs of the u-shaped profile extend in the direction of the axis of rotation R from the apex. The double rotor 240 includes two rotor disks which axially enclose stator spools 375 oriented in the direction of the axis of rotation R. The rotor spools 360, 370 respectively form in each rotor disk a group 380 of rotor spools 360, the legs of the u-shaped profile of which are directed toward one another so that they may be closed by stator spools.

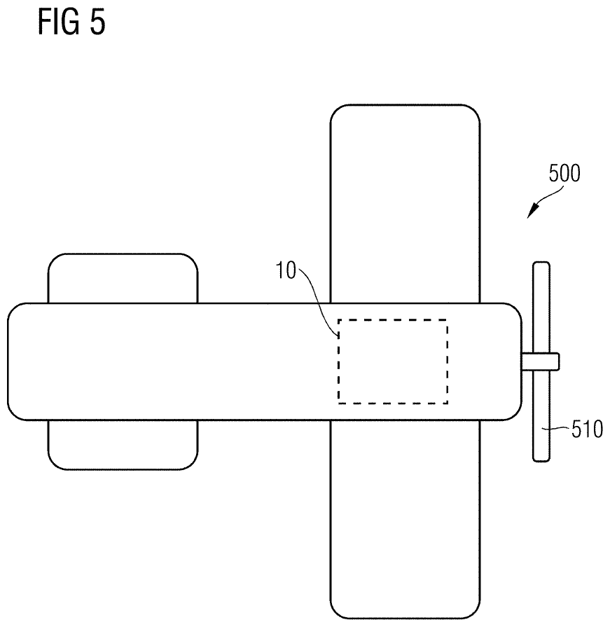

As shown in FIG. 4, in a further exemplary embodiment, the superconducting spools may also be arranged in such a way that the legs of the u-shaped profile V extend in the radial direction.

In all of the exemplary embodiments shown, the rotor 40, 240, RT of the electric machine 10 is cooled to cryogenic temperatures of below 90 Kelvin for operation. For this purpose, for example, as shown in FIG. 4, formed in a rotor shaft S of the rotor RT of the electric machine is a coolant path P, which conducts coolant through the rotor RT. In this way the rotor RT is cooled to cryogenic temperatures.

The hybrid electric aircraft 500 shown in FIG. 5 has an electric machine 10 as described above. The electric machine 10 works as an electric motor and drives a propeller 510 of the hybrid electric aircraft 500.

Although the disclosure has been described and illustrated more specifically in detail by the exemplary embodiments, the disclosure is not restricted by the disclosed examples and other variations may be derived therefrom by a person skilled in the art without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. An electric machine comprising:
at least one group of superconducting spools arranged to guide a magnetic flux at least along a u-shaped profile.

2. The electric machine of claim 1, wherein the superconducting spools of the at least one group surround the u-shaped profile and/or a longitudinal center line of the u-shaped profile circumferentially.

3. The electric machine of claim 1, wherein the superconducting spools have winding planes that extend along curve radii of a curve section of the u-shaped profile.

4. The electric machine of claim 1, wherein the u-shaped profile extends within a profile plane and the superconducting spools have winding planes that extend perpendicular to the profile plane.

5. The electric machine of claim 1, further comprising:
a rotor; and
a stator,
wherein the at least one group of superconducting spools is arranged on the rotor or the stator of the electric machine.

6. The electric machine of claim 1, wherein the at least one group is a plurality of groups of superconducting spools, and
wherein legs of the u-shaped profile respectively extend in a same direction from an apex of the u-shaped profile.

7. The electric machine of claim 1, wherein the at least one group is a plurality of groups of superconducting spools, and
wherein legs of the u-shaped profile of at least two groups of the plurality of groups are directed toward one another.

8. The electric machine of claim 1, wherein the electric machine is an electric motor and/or a generator.

9. The electric machine of claim 1, wherein the superconducting spools comprise yttrium-barium-copper oxide.

10. A hybrid electric vehicle comprising:
an electric machine having at least one group of superconducting spools arranged to guide a magnetic flux at least along a u-shaped profile.

11. The hybrid electric vehicle of claim 10, wherein the hybrid electric vehicle is an aerial vehicle.

12. The hybrid electric vehicle of claim 11, wherein the aerial vehicle is an aircraft.

13. The electric machine of claim 2, wherein the superconducting spools have winding planes that extend along curve radii of a curve section of the u-shaped profile.

14. The electric machine of claim 13, wherein the u-shaped profile extends within a profile plane and the winding planes that extend perpendicular to the profile plane.

15. The electric machine of claim 2, wherein the u-shaped profile extends within a profile plane and the superconducting spools have winding planes that extend perpendicular to the profile plane.
